(19) United States
(12) Patent Application Publication
(10) Pub. No.: US 2026/0031040 A1
(43) Pub. Date: Jan. 29, 2026

(54) PIXEL CIRCUIT, DISPLAY DEVICE INCLUDING THE PIXEL CIRCUIT AND ELECTRONIC DEVICE INCLUDING THE PIXEL CIRCUIT

(71) Applicant: Samsung Display Co., Ltd., Yongin-Si (KR)

(72) Inventors: HYUNJOON KIM, Yongin-si (KR); YOUNGWAN SEO, Yongin-si (KR); JUNGHWAN HWANG, Yongin-si (KR)

(21) Appl. No.: 19/274,686

(22) Filed: Jul. 21, 2025

(30) Foreign Application Priority Data
Jul. 23, 2024 (KR) 10-2024-0097536
Oct. 31, 2024 (KR) 10-2024-0151784

(51) Int. Cl. G09G 3/3233; G09G 3/32

(52) U.S. Cl. CPC G09G 3/3233; G09G 3/32; G09G 2300/043; G09G 2300/0819; G09G 2310/08; G09G 2330/021

(57) ABSTRACT

A display device includes a display panel including pixel circuits and a display panel driver. The pixel circuit includes a first transistor including a control electrode connected to a first node, a first electrode receiving a first driving voltage and as second electrode connected to a second node, a second transistor applying a data voltage to a third node in response to a write gate signal, a third transistor connecting the first node and the second node in response to a compensation gate signal, a first capacitor and a light emitting element including a first electrode connected to the second node and a second electrode receiving a second driving voltage. The first driving voltage has a driving-high voltage or a driving-low voltage, and the second driving voltage has the driving-high voltage and the driving-low voltage. The compensation gate signal may be globally applied.

### CROSS-REFERENCE TO RELATED APPLICATION(S)

This application claims priority, under 35 USC § 119, to Korean Patent Application No. 10-2024-0097536 filed on Jul. 23, 2024 and Korean Patent Application No. 10-2024-0151784 filed on Oct. 31, 2024 in the Korean Intellectual Property Office (KIPO), the contents of which are herein incorporated by reference.

### BACKGROUND

### 1. Field

Embodiments of the present inventive concept relate to a pixel circuit, a display device including the pixel circuit and an electronic device including the pixel circuit. More particularly, embodiments of the present inventive concept relate to a pixel circuit, a display device including the pixel circuit and an electronic device including the pixel circuit in which an emission reliability and an integration improved.

### 2. Description of the Related Art

Generally, a display apparatus includes a display panel and a display panel driver. The display panel includes a plurality of gate lines, a plurality of data lines and a plurality of pixels. The display panel driver includes a gate driver providing a gate signal to the gate lines, a data driver providing a data voltage to the data lines and a driving controller controlling the gate driver and the data driver.

Recently, display devices that provide virtual reality (VR) or augmented reality (AR) have been gaining prominence. For this type of application, it is desirable for a display apparatus to have a small area and high integration. In this case, since a pitch occupied by the pixel circuit is narrowed, the number of transistors of the pixel circuit and the number of signals applied to the pixel circuit may have restriction.

### SUMMARY

Embodiments of the present inventive concept provide a pixel circuit having a low area, high integration, and reduced leakage current.

Embodiments of the present inventive concept also provide a display device including the pixel circuit,

Embodiments of the present inventive concept also provide an electronic device including the pixel circuit.

According to embodiments, a display device may include a display panel including a plurality of pixel circuits and a display panel driver configured to drive the display panel. The pixel circuit may include a first transistor including a control electrode connected to a first node, a first electrode receiving a first driving voltage and as second electrode connected to a second node, a second transistor configured to apply a data voltage to a third node in response to a write gate signal, a third transistor configured to connect the first node and the second node in response to a compensation gate signal, a first capacitor including a first electrode connected to the third node and a second electrode connected to the first node and a light emitting element including a first electrode connected to the second node and a second electrode receiving a second driving voltage. The first driving voltage may have a driving-high voltage or a driving-low voltage, and the second driving voltage may have the driving-high voltage and the driving-low voltage. The compensation gate signal may be a global signal that is globally applied to at least two pixel-rows with a same timing.

In an embodiment, the pixel circuit may further include a fourth transistor configured to apply an initialization voltage to the second node in response to an initialization gate signal. The initialization voltage signal may be globally applied.

In an embodiment, the pixel circuit may further include a second capacitor including a first electrode receiving the initialization voltage and a second electrode connected to the third node.

In an embodiment, the pixel circuit may further include a fourth transistor configured to apply an initialization voltage to the second node in response to an initialization gate signal. A frame period in which the pixel circuit is driven may include first to seventh periods. In the first period, the compensation gate signal may have an inactive level, the initialization gate signal may have an inactive level, the write gate signal may have an inactive level, and the second driving voltage may have the driving-high voltage.

In an embodiment, in the second period following the first period, the compensation gate signal may have an active level, the initialization gate signal may have an active level, the write gate signal may have an active level, the data voltage may have a reference data voltage, and the first driving voltage may have the driving-low voltage.

In an embodiment, in the third period following the second period, the compensation gate signal may have an active level, the initialization gate signal may have an inactive level, the write gate signal may have an inactive level, and the first driving voltage may have the driving-high voltage.

In an embodiment, in the fourth period following the third period, the compensation gate signal may have an inactive level, the initialization gate signal may have an inactive level, the write gate signal may have an inactive level, and the first driving voltage may transition between the driving-high voltage and the driving-low voltage.

In an embodiment, in the fourth period following the third period, the compensation gate signal may have an inactive level, the initialization gate signal may have an inactive level, the write gate signal may have an inactive level, and the first driving voltage may have the driving high voltage.

In an embodiment, in the fifth period following the fourth period, the write gate signal may have an active level, the data voltage may have a pixel data voltage, and the first driving voltage may have the driving-low voltage.

In an embodiment, in the fifth period following the fourth period, the write gate signal may have an active level, the data voltage may have a pixel data voltage, and the first driving voltage may have the driving-low voltage.

In an embodiment, in the sixth period following the fifth period, the compensation gate signal may have an inactive level, the initialization gate signal may have an active level, the write gate signal may have an inactive level, and the first driving voltage may have the driving-high voltage.

In an embodiment, in the sixth period following the fifth period, the compensation gate signal may have an inactive level, the initialization gate signal may have an active level, the write gate signal may have an inactive level, and the first driving voltage may have the driving-low voltage.

In an embodiment, in the seventh period following the sixth period, the compensation gate signal may have an inactive level, the initialization gate signal may have an inactive level, the write gate signal may have an inactive level, the first driving voltage may have the driving-high voltage, and the second driving voltage may have the driving-low voltage.

In an embodiment, the pixel circuit may further include a fourth transistor configured to apply an initialization voltage to the second node in response to an initialization gate signal. The first transistor may be a P-type transistor, and the second to fourth transistors may be N-type transistors.

In an embodiment, the pixel circuit may further include a fourth transistor configured to apply an initialization voltage to the second node in response to an initialization gate signal and a second capacitor including a first electrode receiving the initialization voltage and a second electrode connected to the third node. The second transistor may include a control electrode receiving the write gate signal, a first electrode receiving the data voltage and a second electrode connected to the third node. The third transistor may include a control electrode receiving the compensation gate signal, a first electrode connected to the second node and a second electrode connected to the first node. The fourth transistor may include a control electrode receiving the initialization gate signal, a first electrode receiving the initialization voltage and a second electrode connected to the second node.

In an embodiment, the pixel circuits may be located on a silicon-based substrate.

According to embodiments, a pixel circuit may include a first transistor including a control electrode connected to a first node, a first electrode receiving a first driving voltage and a second electrode connected to a second node, a second transistor including a control electrode receiving a write gate signal, a first electrode receiving a data voltage and a second electrode connected to a third node, a third transistor including a control electrode receiving a compensation gate signal, a first electrode connected to the second node and a second electrode connected to the first node, a fourth transistor including a control electrode receiving an initialization gate signal, a first electrode receiving an initialization voltage and a second electrode connected to the second node, a first capacitor including a first electrode connected to the third node and a second electrode connected to the first node, a second capacitor including a first electrode receiving a reference voltage and a second electrode connected to the third node and a light emitting element including a first electrode connected to the second node and a second electrode receiving a second driving voltage. The first driving voltage and the second driving voltage may change during a frame period.

In an embodiment, the frame period in which the pixel circuit is driven may include a first initialization period, a compensation period, a writing period, a second initialization period and an emission period. In the first initialization period, the compensation gate signal may have an active level, the initialization gate signal may have an active level, the write gate signal may have an active level, the data voltage may have a reference data voltage, the first driving voltage may have a driving-low voltage, and the second driving voltage may have the driving-high voltage. In the compensation period, the compensation gate signal may have an active level, the initialization gate signal may have an inactive level, the first driving voltage may have a driving-high voltage, and the second driving voltage may have the driving-high voltage. In the writing period, the write gate signal may have an active level for part of the writing period, the data voltage may have a pixel data voltage, the first driving voltage may have a driving-low voltage, and the second driving voltage may have the driving-high voltage. In the second initialization period, the initialization gate signal may have an active level, the write gate signal may have an active level, the first driving voltage may have a driving-low voltage, and the second driving voltage may have the driving-high voltage. In the emission period, the first driving voltage may have a driving-high voltage, and the second driving voltage may have the driving-low voltage.

In an embodiment, the first transistor may be a P-type transistor, and the second to fourth transistors may be N-type transistors.

In an embodiment, the reference voltage may be the initialization voltage.

According to embodiments, an electronic device may include a display panel including a plurality of pixel circuits, a display panel driver configured to drive the display panel based on an input control signal and a processor configured to output the input control signal. The pixel circuit may include a first transistor including a control electrode connected to a first node, a first electrode receiving a first driving voltage and as second electrode connected to a second node, a second transistor configured to apply a data voltage to a third node in response to a write gate signal, a third transistor configured to connect the first node and the second node in response to a compensation gate signal, a first capacitor including a first electrode connected to the third node and a second electrode connected to the first node and a light emitting element including a first electrode connected to the second node and a second electrode receiving a second driving voltage. The first driving voltage may have a driving-high voltage or a driving-low voltage, and the second driving voltage may have the driving-high voltage or the driving-low voltage. The compensation gate signal may be a global signal which is applied to at least two pixel-rows with a same timing.

In an embodiment, the pixel circuit may further include a fourth transistor configured to apply an initialization voltage to the second node in response to an initialization gate signal. The initialization voltage signal may be globally applied.

In an embodiment, the pixel circuit may further include a second capacitor including a first electrode receiving the initialization voltage and a second electrode connected to the third node.

As described above, a pixel circuit may have a 4T2C structure. A threshold voltage of a driving transistor may be compensated through the compensation transistor. Accordingly, a driving reliability of the pixel circuit may be improved. Additionally, an emission reliability of the light emitting element may be improved. Additionally, the pixel circuit may have 4T2C structure, so that an integration of the pixel circuit may be improved.

Additionally, a first driving voltage may have a driving-high voltage or a driving-low voltage in a frame period, and the second driving voltage may have the driving-high voltage or the driving-low voltage in a frame period. In an emission period, the first driving voltage may have the driving-high voltage, and the second driving voltage may have the driving-low voltage. Accordingly, a plurality of pixel-rows may emit light. For example, the pixel-rows may emit light simultaneously. For example, the pixel-rows may be driven to emit light simultaneously.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the present inventive concept.

FIG. 2 is a block diagram illustrating an example of signals applied to a pixel circuit included in a display device of FIG. 1.

FIG. 3 is a circuit diagram illustrating an example of a pixel circuit included in a display device of FIG. 1.

FIG. 4 is a timing diagram illustrating an example of signals applied to a pixel circuit of FIG. 3.

FIG. 5 is a circuit diagram illustrating an operation of a pixel circuit of FIG. 3 in a first period of FIG. 4.

FIG. 6 is a circuit diagram illustrating an operation of a pixel circuit of FIG. 3 in a second period of FIG. 4.

FIG. 7 is a circuit diagram illustrating an operation of a pixel circuit of FIG. 3 in a third period of FIG. 4.

FIG. 8 is a circuit diagram illustrating an operation of a pixel circuit of FIG. 3 in a fifth period of FIG. 4.

FIG. 9 is a circuit diagram illustrating an operation of a pixel circuit of FIG. 3 in a sixth period of FIG. 4.

FIG. 10 is a circuit diagram illustrating an operation of a pixel circuit of FIG. 3 in a seventh period of FIG. 4.

FIG. 11 is a timing diagram illustrating an example of signals applied to a pixel circuit of FIG. 3.

FIG. 12 is a timing diagram illustrating an example of signals applied to a pixel circuit of FIG. 3.

FIG. 13 is a timing diagram illustrating an example of signals applied to a pixel circuit of FIG. 3.

FIG. 14 is a circuit diagram illustrating an example of a pixel circuit included in a display device of FIG. 1.

FIG. 15 is a timing diagram illustrating an example of signals applied to a pixel circuit of FIG. 14.

FIG. 16 is a circuit diagram illustrating an example of a pixel circuit included in a display device of FIG. 1.

FIG. 17 is a diagram illustrating an example of a pixel circuit included in a display device of FIG. 1 is located on a substrate.

FIG. 18 is a block diagram illustrating an electronic device according to an embodiment of the present inventive concept.

FIG. 19 is a diagram illustrating an example in which the electronic device of FIG. 18 is implemented as a smart phone.

FIG. 20 is a diagram illustrating an example in which the electronic device of FIG. 18 is implemented as a virtual reality display system.

### DETAILED DESCRIPTION OF THE INVENTIVE CONCEPT

Hereinafter, the present inventive concept will be explained in detail with reference to the accompanying drawings.

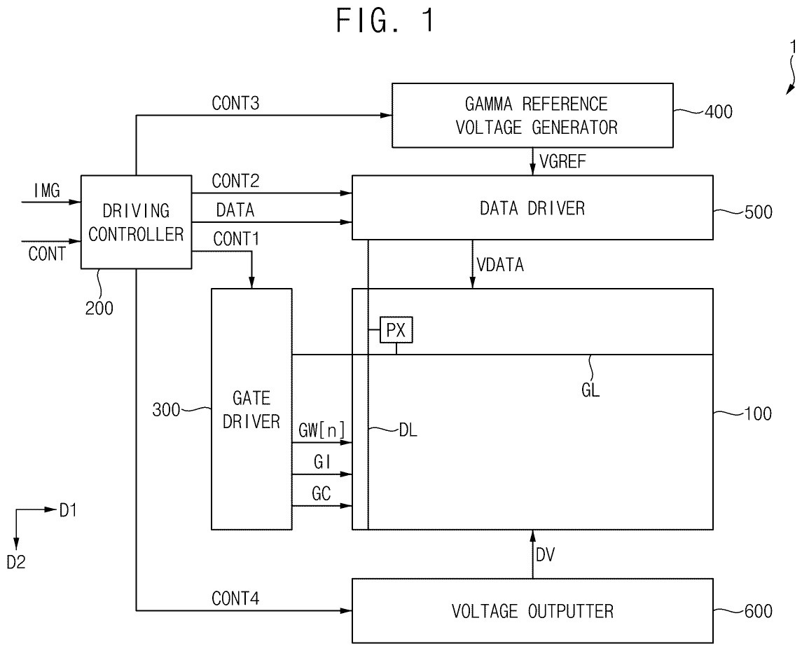

FIG. 1 is a block diagram illustrating a display device 1 according to embodiments of the present inventive concept.

Referring to FIG. 1, the display device 1 may include a display panel 100 and a display panel driver. The display panel driver 110 may include a driving controller 200, a gate emission driver 300, a gamma reference voltage generator 400, a data driver 500, a voltage outputter 600.

The display panel 100 may have a display region on which an image is displayed and a peripheral region adjacent to the display region.

The display panel 100 may include a plurality of gate lines GL, a plurality of data lines DL and a plurality of pixel circuits PX electrically connected to the gate lines GL and the data lines DL. The gate lines GL may extend in a first direction D1. The data lines DL may extend in a second direction D2 crossing the first direction D1.

The driving controller 200 may receive input image data IMG and an input control signal CONT from an external device. For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4 and a data signal DATA based on the input image data IMG and the input control signal CONT.

The driving controller 200 may generate the first control signal CONT1 for controlling an operation of the gate emission driver 300 based on the input control signal CONT, and output the first control signal CONT1 to the gate emission driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the voltage outputter 600 based on the input control signal CONT, and output the fourth control signal CONT4 to the voltage outputter 600.

The gate driver 300 may generate gate signals driving the gate lines GL in response to the first control signal CONT1 received from the driving controller 200. The gate driver 300 may output the gate signals to the gate lines GL. For example, the gate signals may include an initialization gate signal GI, a compensation gate signal GC and a write gate signal GW.

In an embodiment, the gate driver 300 may be disposed in the peripheral region. In an embodiment, the gate driver 300 may be integrated in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be disposed in the driving controller 200, or in the data driver 500.

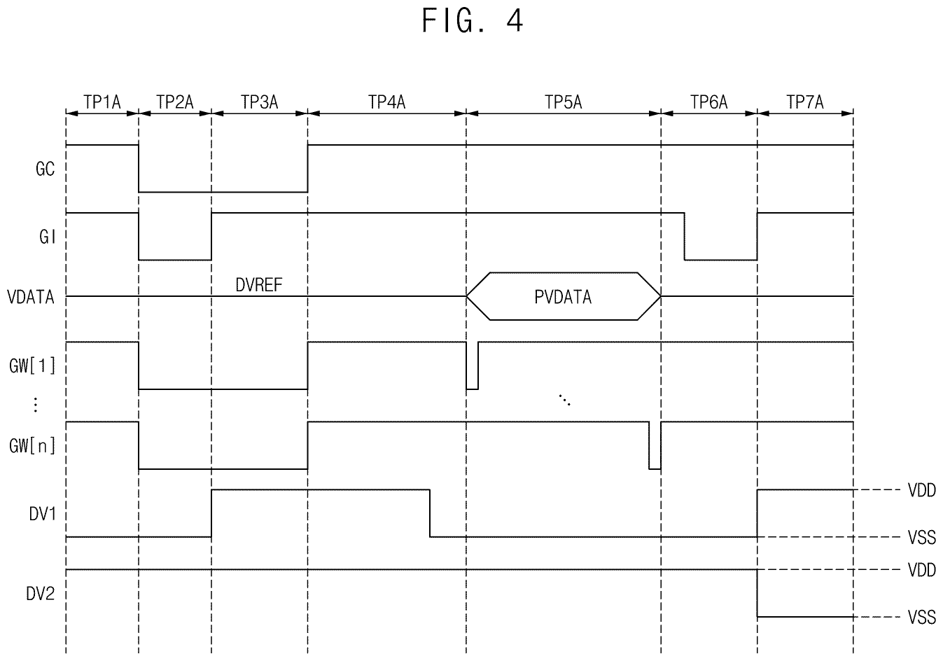

The data driver 500 may receive the second control signal CONT2 and the data signal DATA from the driving controller 200, and receive the gamma reference voltages VGREF from the gamma reference voltage generator 400. The data driver 500 may convert the data signal DATA into data voltages having an analog type using the gamma reference voltages VGREF. The data voltages having an analog type may be a pixel data voltage PVDATA of FIG. 4. The pixel data voltage PVDATA of FIG. 4 may be a voltage corresponding to the data signal DATA. The data driver 500 may output the data voltages VDATA to the data lines DL.

In an embodiment, the data driver 500 may be disposed in the peripheral region. In an embodiment, the data driver 500 may be integrated in the peripheral region.

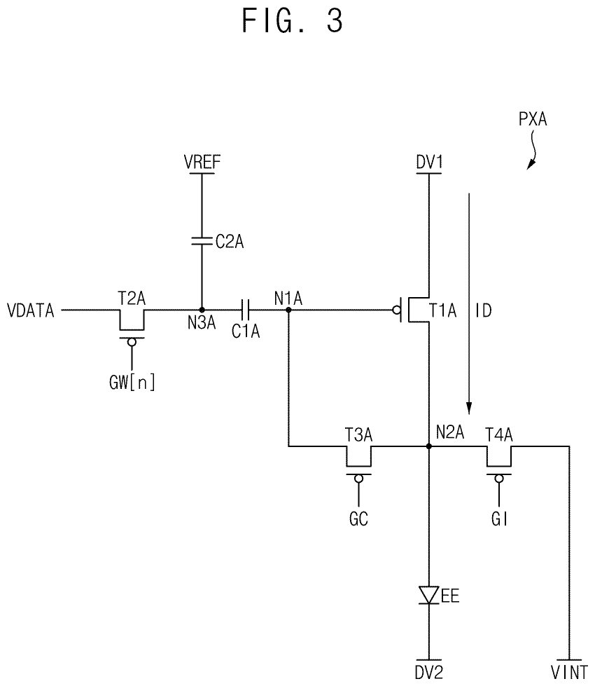

The voltage outputter 600 may generate driving voltage DV in response to the fourth control signal CONT4 received from the driving controller 200. The voltage outputter 600 may output the driving voltage DV in response to the fourth control signal CONT4. The voltage outputter 600 may output a driving-high voltage VDD of FIG. 4 or a driving-low voltage VSS of FIG. 4 as a first driving voltage DV1 in response to the fourth control signal CONT4. The voltage outputter 600 may output the driving-high voltage VDD of FIG. 4 or the driving-low voltage VSS of FIG. 4 as a second driving voltage DV2 in response to the fourth control signal CONT4. The driving-high voltage VDD of FIG. 4 may be higher than the driving-low voltage VSS of FIG. 4. In an embodiment, the driving voltage DV may further include an initialization voltage VINT of FIG. 3 and a reference voltage VREF of FIG. 3.

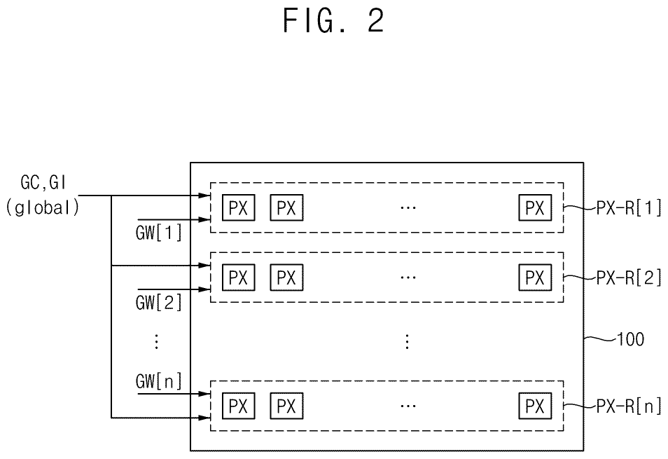

FIG. 2 is a block diagram illustrating an example of signals applied to a pixel circuit PX included in a display device 1 of FIG. 1.

Referring to FIG. 1 and FIG. 2, the display panel 100 may include a plurality of pixel-rows PX-R[1], PX-R[2] to PX-R[n]. The pixel-row may mean a plurality of the pixel circuits PX connected to a same write gate line. For example, the pixel circuits PX connected to the same write gate line may receive a same write gate signal GW[n]. Pixel circuits of the first pixel-row PX-R[1] may receive a first write gate signal GW[1]. Pixel circuits of the second pixel-row PX-R[2] may receive a second write gate signal GW[2]. Pixel circuits of the N-th pixel-row PX-R[n] may receive an N-th write gate signal GW[n].

In the present embodiment, the compensation gate signal GC[n] may be a global signal. A global signal is a signal that is globally applied, meaning it is applied to at least two pixel-rows of the pixel-rows PX-R[1], PX-R[2] . . . . PX-R[n] with the same timing. For example, a global signal may be applied to all pixel circuits included in the display panel 100 with the same timing. In the present embodiment, the initialization gate signal GI may be globally applied.

In an embodiment, the write gate signal GW[n] may be a progressive signal. A “progressive signal” may mean a signal that is progressively applied to the pixel-rows PX-R[1], PX-R[2] . . . . PX-R[n] at different times. In an embodiment, the write gate signal GW[n] may be sequentially applied to the pixel-rows PX-R[1], PX-R[2] to PX-R[n].

In the present embodiment, the write gate signal GW[n] may be progressively applied, and the compensation gate signal GC and the initialization gate signal GI may be globally applied. The compensation gate signal GC may be globally applied, so that the number of stages generating the compensation gate signal GC may be reduced. Additionally, the initialization gate signal GI may be globally applied, so that the number of stages generating the initialization gate signal GI may be reduced. Accordingly, an integration of the gate driver 300 may be improved. Additionally, a power consumption of the display device 1 may be reduced.

FIG. 3 is a circuit diagram illustrating an example of a pixel circuit PX included in a display device 1 of FIG. 1.

Referring to FIG. 1, FIG. 2, and FIG. 3, a pixel circuit PXA may include a first transistor T1A, a second transistor T2A, a third transistor T3A, a fourth transistor T4A, a first capacitor C1A, a second capacitor C2A and a light emitting element EE.

The first transistor T1A may include a control electrode connected to a first node N1A, a first electrode receiving the first driving voltage DV1 and a second electrode connected to a second node N2A. The first transistor T1A may generate a driving current ID based on a voltage of the first node N1A. The first transistor T1A may output the driving current ID to the second node N2A based on the voltage of the first node N1A. For example, the first transistor T1A may be referred to as a “driving transistor.”

The second transistor T2A may include a control electrode receiving the write gate signal GW[n], a first electrode receiving the data voltage VDATA and a second electrode connected to a third node N3A. The second transistor T2A may apply the data voltage VDATA to the third node N3A in response to the write gate signal GW[n]. For example, the second transistor T2A may be referred to as a “writing transistor.”

The third transistor T3A may include a control electrode receiving the compensation gate signal GC, a first electrode connected to the second node N2A and a second electrode connected to the first node N1A. The third transistor T3A may connect the third node N3A and the first node N1A in response to the compensation gate signal GC. For example, the third transistor T3A may diode-connect the first transistor T1A. For example, the third transistor T3A may be referred to as a “compensation transistor.”

The fourth transistor T4A may include a control electrode receiving the initialization gate signal GI, a first electrode receiving the initialization voltage VINT and a second electrode connected to the second node N2A. The fourth transistor T4A may apply the initialization voltage to the second node N2A in response to the initialization gate signal GI. For example, the fourth transistor T4A may be referred to as an “initialization transistor.”

In an embodiment, the first to fourth transistors T1A, T2A, T3A and T4A may be P-type transistors.

The first capacitor C1A may include a first electrode connected to the third node N3A and a second electrode connected to the first node N1A. The first capacitor C1A may apply a coupling voltage by coupling a change of a voltage of the third node N3A to the first node N1A.

The second capacitor C2A may include a first electrode receiving the reference voltage VREF and a second electrode connected to the third node N3A.

The light emitting element EE may include a first electrode connected to the second node N2A and a second electrode receiving the second driving voltage DV2. The light emitting element EE may emit light based on the driving current ID. In an embodiment, the light emitting element EE may be an organic light emitting diode (OLED), but the present inventive concept is not limited thereto. In other embodiments, the light emitting element EE may be a nano light emitting diode, quantum dot light emitting diode, micro light emitting diode, and in organic light emitting diode, or any other suitable light emitting element.

In the present embodiment, the pixel circuit PXA may have a four-transistors-and-two-capacitors (4T2C) structure. In the present embodiment, a threshold voltage of the first transistor T1A may be compensated through the third transistor T3A. Accordingly, a driving reliability of the pixel circuit PXA may be improved. Additionally, an emission reliability of the light emitting element EE may be improved. Additionally, the pixel circuit PXA may have the 4T2C structure, so that an integration of the pixel circuit PXA may be improved.

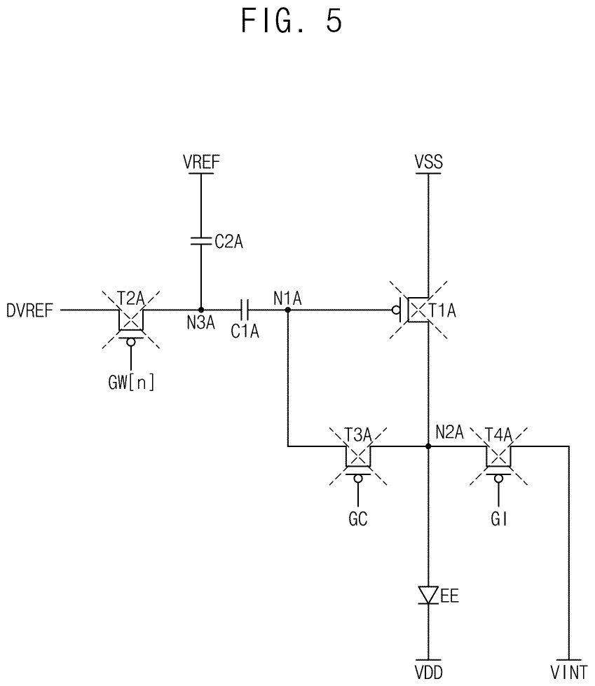

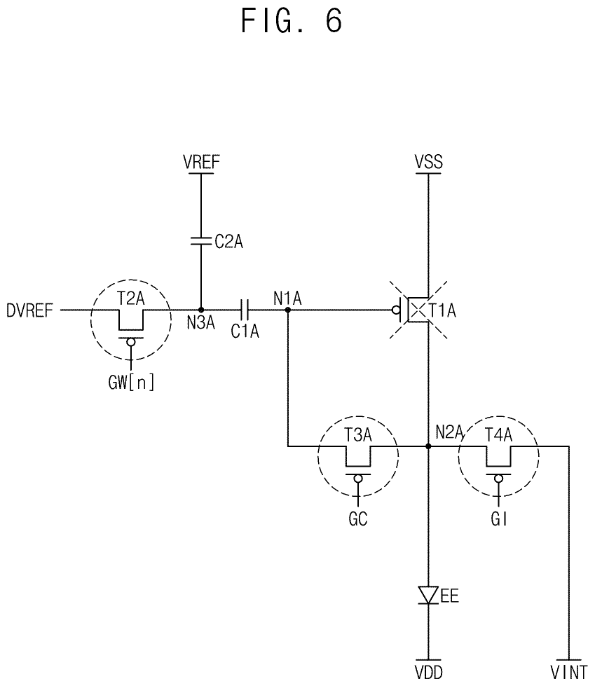

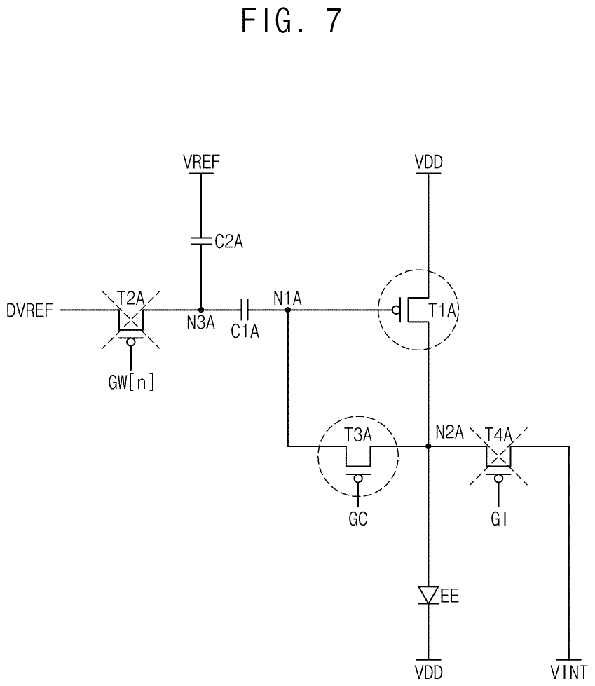

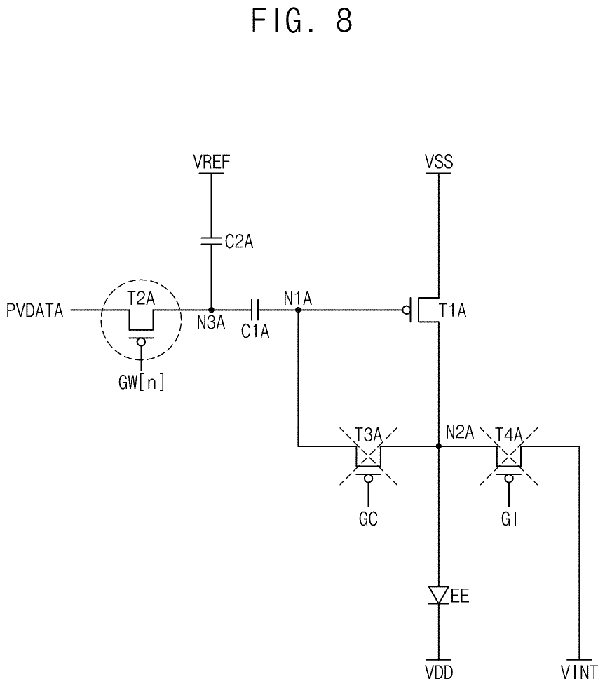

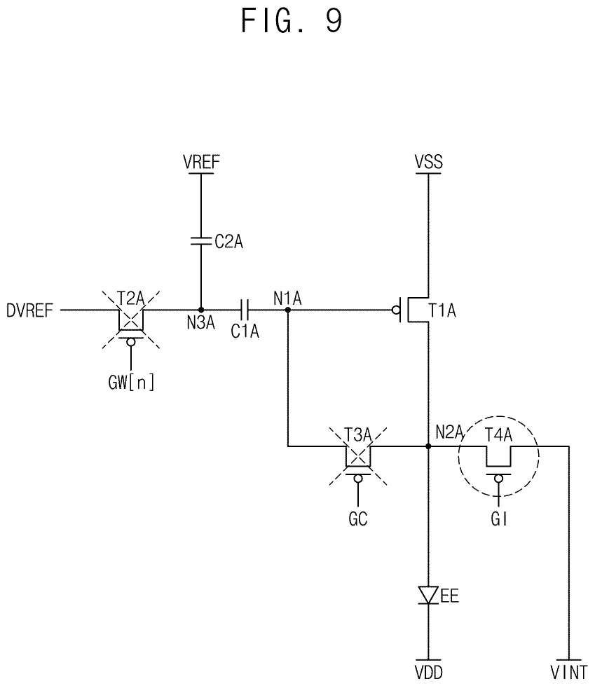

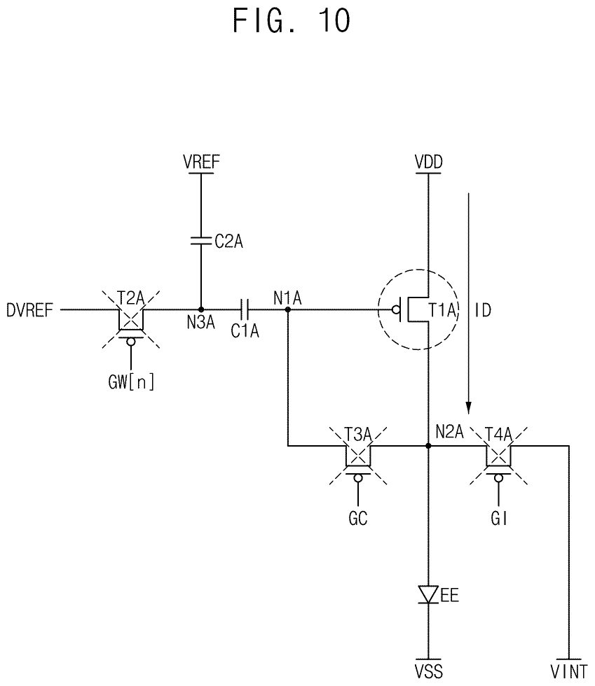

FIG. 4 is a timing diagram illustrating an example of signals applied to a pixel circuit PXA of FIG. 3. FIG. 5 is a circuit diagram illustrating an operation of a pixel circuit PXA of FIG. 3 in a first period TP1A of FIG. 4. FIG. 6 is a circuit diagram illustrating an operation of a pixel circuit PXA of FIG. 3 in a second period TP2A of FIG. 4. FIG. 7 is a circuit diagram illustrating an operation of a pixel circuit PXA of FIG. 3 in a third period TP3A of FIG. 4. FIG. 8 is a circuit diagram illustrating an operation of a pixel circuit PXA of FIG. 3 in a fifth period TP5A of FIG. 4. FIG. 9 is a circuit diagram illustrating an operation of a pixel circuit PXA of FIG. 3 in a sixth period TP6A of FIG. 4. FIG. 10 is a circuit diagram illustrating an operation of a pixel circuit PXA of FIG. 3 in a seventh period TP7A of FIG. 4.

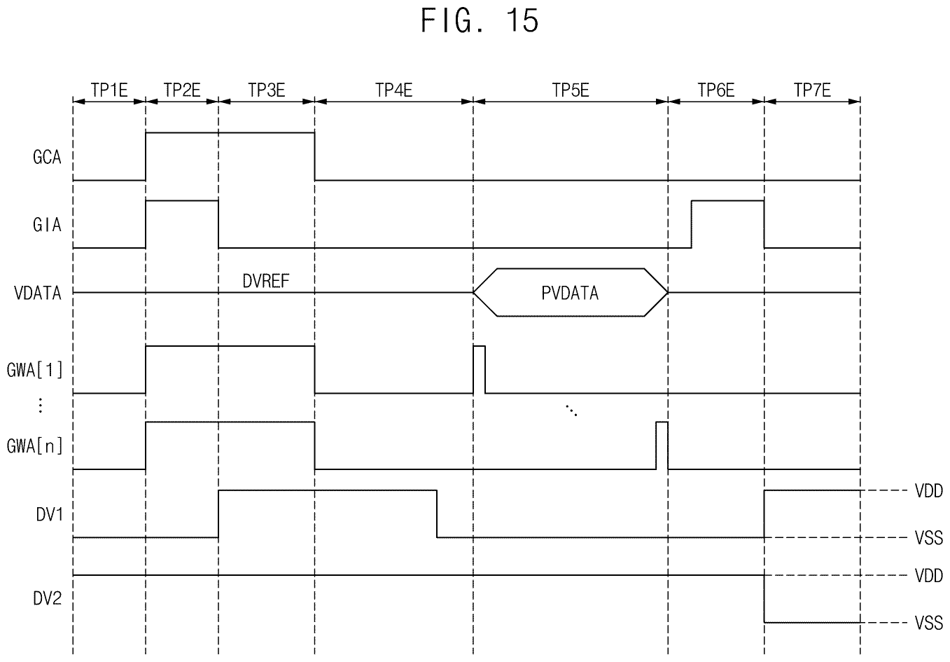

Referring to FIG. 1 to FIG. 10, a frame period in which the pixel circuit PXA is driven may include first to seventh periods TP1A, TP2A, TP3A, TP4A, TP5A, TP6A and TP7A. One period follows another, as illustrated in FIG. 4, FIG. 11, FIG. 12, FIG. 13, and FIG. 15. In the embodiments shown, one period immediately follows another.

In the first period TP1A, the compensation gate signal GC may have an inactive level, the initialization gate signal GI may have an inactive level, the data voltage VDATA may have the reference data voltage DVREF, the write gate signal GW[n] may have an inactive level, the first driving voltage DV1 may have the driving-low voltage VSS and the second driving voltage DV2 may have the driving-high voltage VDD.

In the first period TP1A, the first driving voltage DV1 may have the driving-low voltage VSS, so that the first transistor TA may stop generating the driving current ID. Additionally, the second driving voltage DV2 may have the driving-high voltage VDD, so that the light emitting element EE may stop emitting light. For example, the first period TP1A may be referred to as an “emission stop period.”

In the second period TP2A, the compensation gate signal GC may have an active level, the initialization gate signal GI may have an active level, the data voltage VDATA may have the reference data voltage DVREF, the write gate signal GW[n] may have an active level, the first driving voltage DV1 may have the driving-low voltage VSS and the second driving voltage DV2 may have the driving-high voltage VDD.

In the second period TP2A, the fourth transistor T4A may be turned on in response to the initialization gate signal GI. Additionally, the third transistor T3A may be turned on in response to the compensation gate signal GC. The third transistor T3A and the fourth transistor T4A may be turned on, so that the initialization voltage VINT may be applied to the first node N1A. Accordingly, the first node N1A may be initialized as the initialization voltage VINT. In the second period TP2A, the second transistor T2A may be turned on in response to the write gate signal GW[n]. The second transistor T2A may be turned on, so that the reference data voltage DVREF may be applied to the third node N3A. For example, the second period TP2A may be referred to as a “first initialization period.”

In the third period TP3A, the compensation gate signal GC may have an active level, the initialization gate signal GI may have an inactive level, the data voltage VDATA may have the reference data voltage DVREF, the write gate signal GW[n] may have an active level, the first driving voltage DV1 may have the driving-high voltage VDD and the second driving voltage DV2 may have the driving-high voltage VDD.

In the third period TP3A, the fourth transistor T4A may be turned off in response to the initialization gate signal GI. Additionally, the third transistor T3A may be turned on in response to the compensation gate signal GC. In the third period TP3A, the first driving voltage DV1 may have the driving-high voltage VDD. The first driving voltage DV1 may have the driving-high voltage VDD, so that the first transistor T1A may be turned on. The third transistor T3A may diode-connect the first transistor T1A. Accordingly, a voltage in which a threshold voltage of the first transistor T1A is compensated may be applied to the first node N1A. For example, in the third period TP3A, a voltage of the first node N1A may be a voltage which is a sum of the driving-high voltage VDD and the threshold voltage of the first transistor T1A. For example, the third period TP3A may be referred to as a “compensation period.”

In the fourth period TP4A, the compensation gate signal GC may have an inactive level, the initialization gate signal GI may have an inactive level, the data voltage VDATA may have the reference data voltage DVREF, the write gate signal GW[n] may have an inactive level, the first driving voltage DV1 may transition between the driving-high voltage VDD and the driving-low voltage VSS, and the second driving voltage DV2 may have the driving-high voltage VDD. For example, the fourth period TP4A may be referred to as a “writing waiting period.”

In the fifth period TP5A, the compensation gate signal GC may have an inactive level, the initialization gate signal GI may have an inactive level, the data voltage VDATA may have the pixel data voltage PVREF, the write gate signal GW[n] may have an active level, the first driving voltage DV1 may have the driving-low voltage VSS and the second driving voltage DV2 may have the driving-high voltage VDD.

In the fifth period TP5A, the third transistor T3A may be turned off in response to the compensation gate signal GC. Additionally, the fourth transistor T4A may be turned off in response to the compensation gate signal GC. In the fifth period TP5A, the pixel data voltage PVDATA may be applied to the third node N3A in response to the write gate signal GW[n]. The first capacitor C1A may couple a change of a voltage of the third node N3A and apply the coupling voltage to the first node N1A. For example, in the fifth period TP5A, a voltage of the first node N1A may be a sum of a difference between the pixel data voltage PVDATA and the reference data voltage DVREF, and a voltage of the first node N1A in the third period TP4A. Additionally, the first driving voltage DV1 may have the driving-low voltage VSS, so that the first transistor TA may not output the driving current ID. In the fifth period TP5A, the data voltage VDATA may be sequentially applied to the selected pixel-rows PX-R[1]. PX-R[2] . . . PX-R[n] according to the progressive application of the write gate signal GW[1], GW[2], . . . GW[n]. The fifth period TP5A may be referred to as a “writing period.”.

In the sixth period TP6A, the compensation gate signal GC may have an inactive level, the initialization gate signal GI may have an active level, the data voltage VDATA may have the reference data voltage DVREF, the write gate signal GW[n] may have an inactive level, the first driving voltage DV1 may have the driving-low voltage VSS and the second driving voltage DV2 may have the driving-high voltage VDD.

In the sixth period TP6A, the second transistor T2A may be turned off in response to the write gate signal GW[n]. Additionally, the third transistor T3A may be turned off in response to the compensation gate signal GC. In the sixth period TP6A, the fourth transistor T4A may be turned on in response to the initialization gate signal GI. The fourth transistor T4A being turned on allows the initialization voltage VINT to be applied to the second node N2A. For example, the second node N2A may be initialized as the initialization voltage VINT. The sixth period TP6A may be referred to as a “second initialization period.”

In the seventh period TP7A, the compensation gate signal GC may have an inactive level, the initialization gate signal GI may have an inactive level, the data voltage VDATA may have the reference data voltage DVREF, the write gate signal GW[n] may have an inactive level, the first driving voltage DV1 may have the driving-high voltage VDD and the second driving voltage DV2 may have the driving-low voltage VSS.

In the seventh period TP7A, the first driving voltage DV1 may have the driving-high voltage VDD. The first driving voltage DV1 may have the driving-high voltage VDD, so that the first transistor T1A may output the driving current ID based on a voltage of the first node N1A. Additionally, the second driving voltage DV2 may have the driving-low voltage VSS. Accordingly, the light emitting element EE may emit light based on the driving current ID. The seventh period TP7A may be referred to as an “emission period.”

In the present embodiment, the pixel circuit PXA may have a 4T2C structure. In the present embodiment, a threshold voltage of the first transistor TA may be compensated through the third transistor T3A. Accordingly, a driving reliability of the pixel circuit PXA may be improved. Additionally, an emission reliability of the light emitting element EE may be improved. Additionally, the pixel circuit PXA may have 4T2C structure, so that an integration of the pixel circuit PXA may be improved.

Additionally, in the present embodiment, the first driving voltage DV1 may have the driving-high voltage VDD or the driving-low voltage VSS in a frame period, and the second driving voltage DV2 may have the driving-high voltage VDD or the driving-low voltage VSS in a frame period. In the emission period, the first driving voltage DV1 may have the driving-high voltage VDD, and the second driving voltage DV2 may have the driving-low voltage VSS. Accordingly, the pixel-rows PX-R[1], PX-R[2] . . . . PX-R[n] may emit light. For example, the pixel-rows PX-R[1], PX-R[2] . . . . PX-R[n] may emit light simultaneously. For example, the pixel-rows PX-R[1], PX-R[2] . . . . PX-R[n] may be driven to emit light simultaneously. The pixel-rows PX-R[1], PX-R[2] . . . . PX-R[n] may be driven to emit light simultaneously, so that the display device 1 may not include a driver for generating an emission signal. Accordingly, an integration of the display device 1 may be further improved.

FIG. 11 is a timing diagram illustrating an example of signals applied to a pixel circuit PXA of FIG. 3.

A timing diagram may include first to seventh periods TP1B, TP2B, TP3B, TP4B, TP5B, TP6B and TP7B. The timing diagram of FIG. 11 is substantially same as the timing diagram of FIG. 4 except that the first driving voltage DV1 may have the driving-high voltage VDD in the fifth period TP5B and the sixth period TP6B, and the same reference numerals will be used as in FIG. 4. Any repetitive explanation concerning the above elements will be omitted.

Referring to FIG. 1 to FIG. 3 and FIG. 11, the first driving voltage DV1 may have the driving-high voltage VDD in the third to seventh periods TP3B, TP4B, TP5B, TP6B and TP7B.

In the present embodiment, the first driving voltage DV1 may have the driving-high voltage VDD or the driving-low voltage VSS in a frame period, and the second driving voltage DV2 may have the driving-high voltage VDD or the driving-low voltage VSS in a frame period. In the emission period, the first driving voltage DV1 may have the driving-high voltage VDD, and the second driving voltage DV2 may have the driving-low voltage VSS. Accordingly, the pixel-rows PX-R[1], PX-R[2] . . . . PX-R[n] may emit light. For example, the pixel-rows PX-R[1], PX-R[2] . . . . PX-R[n] may emit light simultaneously. For example, the pixel-rows PX-R[1], PX-R[2] . . . . PX-R[n] may be driven to emit light simultaneously. The pixel-rows PX-R[1], PX-R[2] . . . . PX-R[n] may be driven to emit light simultaneously, so that the display device 1 may not include a driver for generating an emission signal. Accordingly, an integration of the display device 1 may be further improved.

FIG. 12 is a timing diagram illustrating an example of signals applied to a pixel circuit PXA of FIG. 3.

A timing diagram of FIG. 12 may include first to seventh periods TP1C, TP2C, TP3C, TP4C, TP5C, TP6C and TP7C. The timing diagram of FIG. 12 is substantially the same as the timing diagram of FIG. 4 except that the first driving voltage DV1 may have the driving-low voltage VSS in the fourth period TP4C. The same reference numerals will be used as in FIG. 4, and any repetitive explanation concerning the above elements will be omitted.

Referring to FIG. 1 to FIG. 3 and FIG. 12, the first driving voltage DV1 may have the driving-low voltage VDD in the fourth period TP4C.

In the present embodiment, the first driving voltage DV1 may have the driving-high voltage VDD or the driving-low voltage VSS in a frame period, and the second driving voltage DV2 may have the driving-high voltage VDD or the driving-low voltage VSS in a frame period. In the emission period (TP7C), the first driving voltage DV1 may have the driving-high voltage VDD, and the second driving voltage DV2 may have the driving-low voltage VSS. Accordingly, the pixel-rows PX-R[1], PX-R[2] . . . . PX-R[n] may emit light. For example, the pixel-rows PX-R[1], PX-R[2] . . . . PX-R[n] may emit light simultaneously. For example, the pixel-rows PX-R[1], PX-R[2] . . . . PX-R[n] may be driven to emit light simultaneously. The pixel-rows PX-R[1], PX-R[2] . . . . PX-R[n] may be driven to emit light simultaneously, so that the display device 1 may not include a driver for generating an emission signal. Accordingly, an integration of the display device 1 may be further improved.

FIG. 13 is a timing diagram illustrating an example of signals applied to a pixel circuit PXA of FIG. 3.

A timing diagram of FIG. 13 may include first to seventh periods TP1D, TP2D, TP3D, TP4D, TP5D, TP6D and TP7D. The timing diagram of FIG. 13 is substantially same as the timing diagram of FIG. 4 except that the first driving voltage DV1 may have the driving-high voltage VDD in the sixth period TP6D. The same reference numerals will be used as in FIG. 4, and any repetitive explanation concerning the above elements will be omitted.

Referring to FIG. 1 to FIG. 3 and FIG. 13, the first driving voltage DV1 may have the driving-high voltage VDD in the sixth period TP6D.

In the present embodiment, the first driving voltage DV1 may have the driving-high voltage VDD or the driving-low voltage VSS in a frame period, and the second driving voltage DV2 may have the driving-high voltage VDD or the driving-low voltage VSS in a frame period. In the emission period, the first driving voltage DV1 may have the driving-high voltage VDD, and the second driving voltage DV2 may have the driving-low voltage VSS. Accordingly, the pixel-rows PX-R[1], PX-R[2] . . . . PX-R[n] may emit light. For example, the pixel-rows PX-R[1], PX-R[2] . . . . PX-R[n] may emit light simultaneously. For example, the pixel-rows PX-R[1], PX-R[2]. PX-R[n] may be driven to emit light simultaneously. The pixel-rows PX-R[1], PX-R[2] . . . . PX-R[n] may be driven to emit light simultaneously, so that the display device 1 may not include a driver for generating an emission signal. Accordingly, an integration of the display device 1 may be further improved.

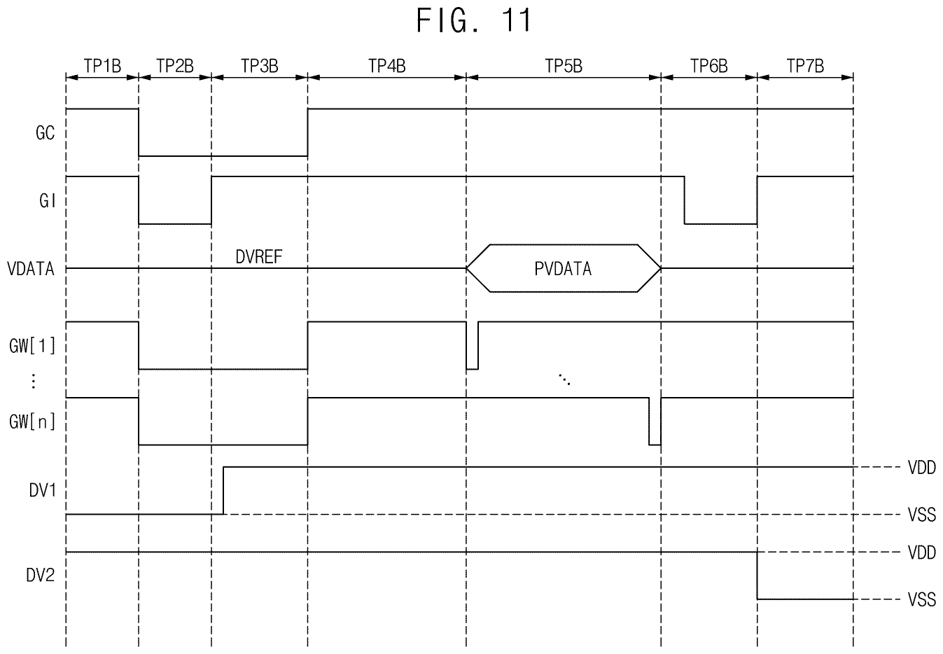

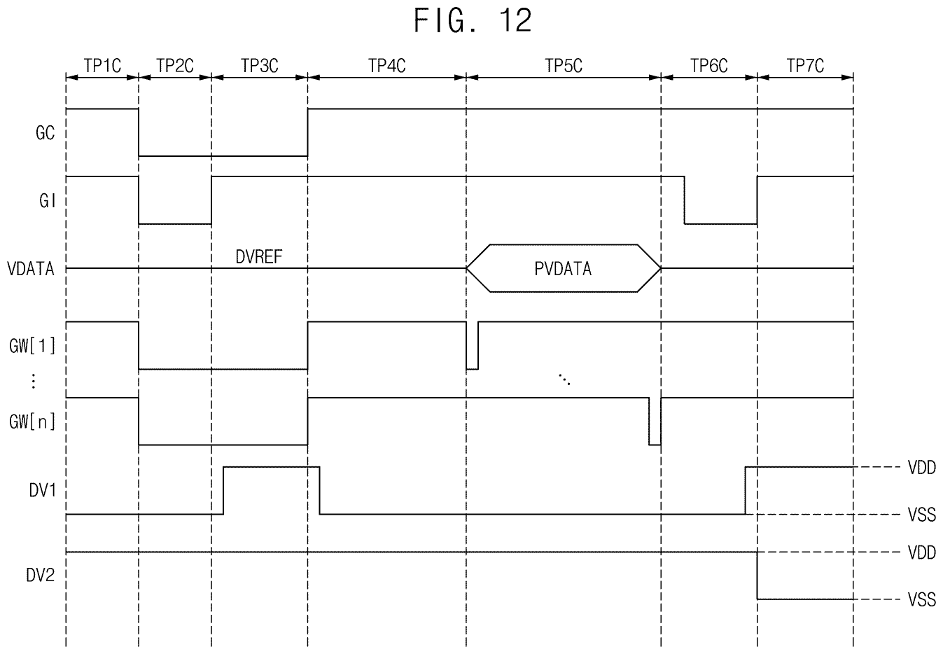

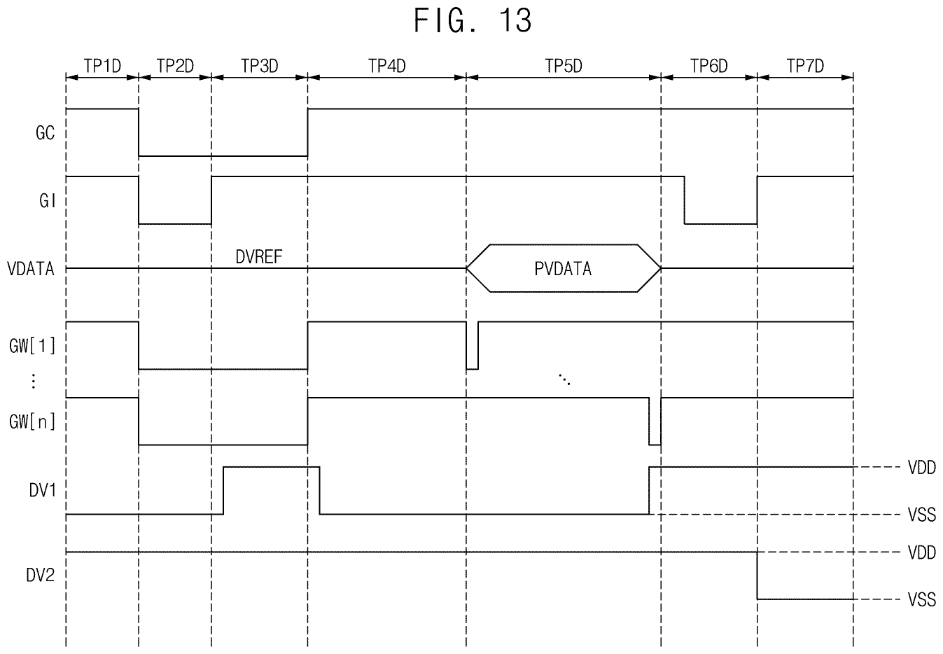

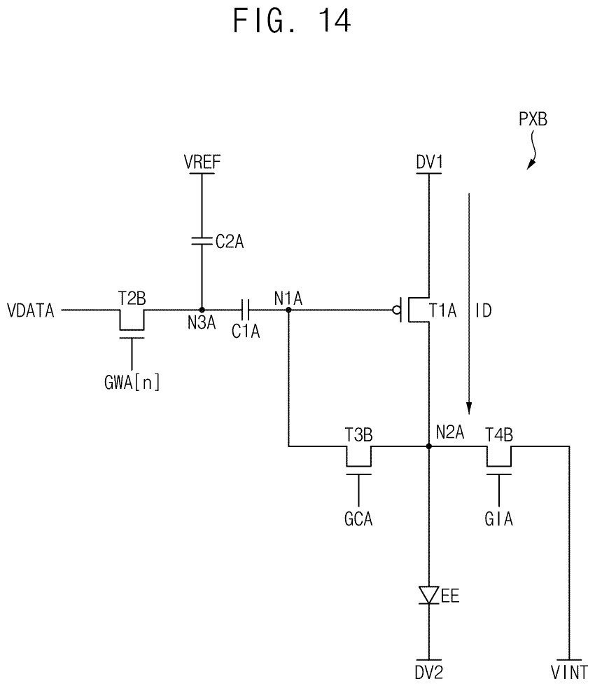

FIG. 14 is a circuit diagram illustrating an example of a pixel circuit PXB included in a display device 1 of FIG. 1. FIG. 15 is a timing diagram illustrating an example of signals applied to a pixel circuit PXB of FIG. 14.

Referring to FIG. 14 and FIG. 15, a pixel circuit PXB may include first to fourth transistors T1A, T2B, T3B and T4B, the first to second capacitor C1A and C2A and the light emitting element EE.

The second transistor T2B may include a control electrode receiving a write gate signal GWA[n], a first electrode receiving the data voltage VDATA and a second electrode connected to the third node N3A. The third transistor T3B may include a control electrode receiving a compensation gate signal GCA, a first electrode connected to the second node N2A and a second electrode connected to the first node N1A. The fourth transistor T4B may include a control electrode receiving an initialization gate signal GIA, a first electrode receiving the initialization voltage VINT and a second electrode connected to the second node N2A. In the present embodiment, the second to fourth transistors T2B, T3B and T4B may be N-type transistors.

The pixel circuit PXB of FIG. 14 is substantially same as the pixel circuit PXA of FIG. 3 except that the second to fourth transistors T2B, T3B and T4B are N-type transistors. Hence, the same reference numerals will be used as in FIG. 3, and any repetitive explanation concerning the above elements will be omitted. Additionally, a timing diagram of FIG. 15 is substantially same as the timing diagram of FIG. 4 except that the initialization gate signal GIA has an opposite phase to the initialization gate signal GI of FIG. 4, the compensation gate signal GCA has an opposite phase to the compensation gate signal GC FIG. 4, and the write gate signal GWA[n] has an opposite phase to the write gate signal GW[n] FIG. 4. The same reference numerals will be used and any repetitive explanation concerning the above elements will be omitted.

In the present embodiment, the pixel circuit PXB may have a 4T2C structure. In the present embodiment, a threshold voltage of the first transistor T1A may be compensated through the third transistor T3B. Accordingly, a driving reliability of the pixel circuit PXB may be improved. Additionally, an emission reliability of the light emitting element EE may be improved. Additionally, the pixel circuit PXB may have the 4T2C structure, so that an integration of the pixel circuit PXB may be improved.

Additionally, in the present embodiment, the first driving voltage DV1 may have the driving-high voltage VDD or the driving-low voltage VSS in a frame period, and the second driving voltage DV2 may have the driving-high voltage VDD or the driving-low voltage VSS in a frame period. In the emission period, the first driving voltage DV1 may have the driving-high voltage VDD, and the second driving voltage DV2 may have the driving-low voltage VSS. Accordingly, the pixel-rows PX-R[1], PX-R[2] . . . . PX-R[n] may emit light. For example, the pixel-rows PX-R[1], PX-R[2] . . . . PX-R[n] may emit light simultaneously. For example, the pixel-rows PX-R[1], PX-R[2] . . . . PX-R[n] may be driven to emit light simultaneously. The pixel-rows PX-R[1], PX-R[2] . . . . PX-R[n] may be driven to emit light simultaneously, so that the display device 1 may not include a driver for generating an emission signal. Accordingly, an integration of the display device 1 may be further improved.

Additionally, in the present embodiment, the second to fourth transistors T2B, T3B and T4B may be N-type transistors. The second to fourth transistors T2B, T3B and T4B may be N-type transistors, so that a driving stability of the pixel circuit PXB may be improved even when using a relatively low power voltage by reducing a current leakage. Additionally, the second to fourth transistors T2B, T3B and T4B may be N-type transistors, so that a switching characteristic of the second to fourth transistors T2B, T3B and T4B may be improved. Accordingly, the driving stability of the pixel circuit PXB may be further improved.

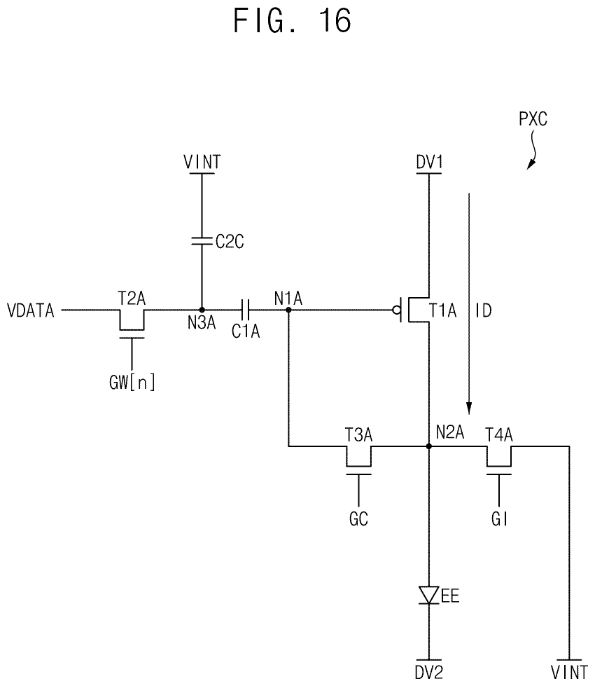

FIG. 16 is a circuit diagram illustrating an example of a pixel circuit PXC included in a display device 1 of FIG. 1.

Referring to FIG. 16, a pixel circuit PXC may include the first to fourth transistors T1A, T2A, T3A and T4A, first to second capacitor C1A and C2C and the light emitting element EE.

The pixel circuit PXC of FIG. 16 is substantially same as the pixel circuit PXA of FIG. 3 except that the initialization voltage VINT, instead of the reference voltage VREF, is applied to a first electrode of the second capacitor C2C. The same reference numerals will be used and any repetitive explanation concerning the above elements will be omitted.

In the present embodiment, the pixel circuit PXC may have a 4T2C structure. In the present embodiment, a threshold voltage of the first transistor T1A may be compensated through the third transistor T3A. Accordingly, a driving reliability of the pixel circuit PXC may be improved. Additionally, an emission reliability of the light emitting element EE may be improved. Additionally, the pixel circuit PXC may have 4T2C structure, so that an integration of the pixel circuit PXC may be improved.

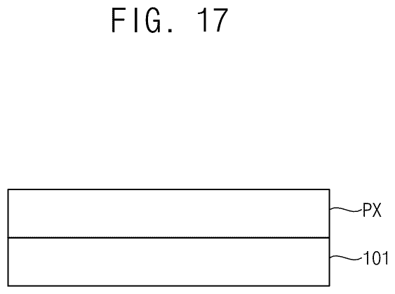

FIG. 17 is a diagram illustrating an example of a pixel circuit PX included in a display device 1 of FIG. 1. The pixel circuit PX is located on a substrate 101.

Referring to FIG. 1 and FIG. 17, the pixel circuit PX may be located (or disposed) on a substrate 101. In an embodiment, the substrate 101 may be a silicon-based substrate. In an embodiment, the pixel circuit PX may be located on a silicon-based substrate. The pixel circuit PX may be located on a silicon-based substrate, so that voltage levels of input signals applied to the pixel circuit PX may be set more precisely. For example, the first driving voltage DV1 may be stably output between the driving-high voltage and the driving-low voltage. Additionally, the second driving voltage DV2 may be stably output between the driving-high voltage and the driving-low voltage.

The silicon-based substrate may include a single-crystal silicon wafer, a polycrystalline silicon wafer, or an amorphous silicon wafer. A semiconductor layer may be formed on the silicon-based substrate through a semiconductor process. For example, the silicon substrate on which the semiconductor layer is formed may be a silicon semiconductor substrate.

In an embodiment, the semiconductor layer may be formed on the silicon-based substrate through a Complementary Metal Oxide Semiconductor (CMOS) process. The semiconductor layer may include a pixel circuit in the form of a CMOS. For example, the pixel circuit PX may include a CMOS circuit including a P-type transistor and an N-type transistor. Accordingly, the display device 1 may be a display-on-silicon (DOS, or, LEDoS (Light Emitting Diode on Silicon)) having a light emitting structure on a silicon semiconductor substrate.

In an embodiment, at least one of the transistors included in the pixel circuit PX may be an N-type transistor. The pixel circuit PX may be located on the silicon-based substrate, so that at least one of the transistors included in the pixel circuit PX may be stably formed as an N-type transistor.

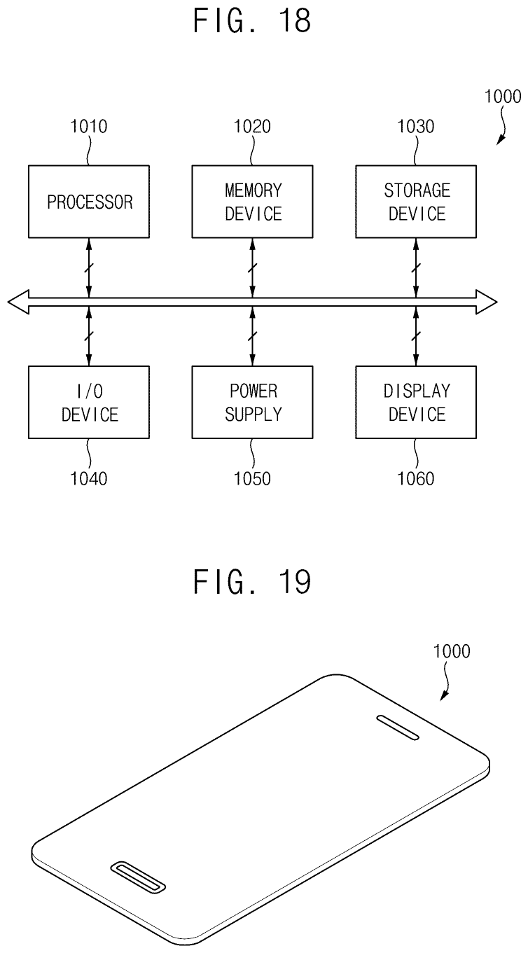

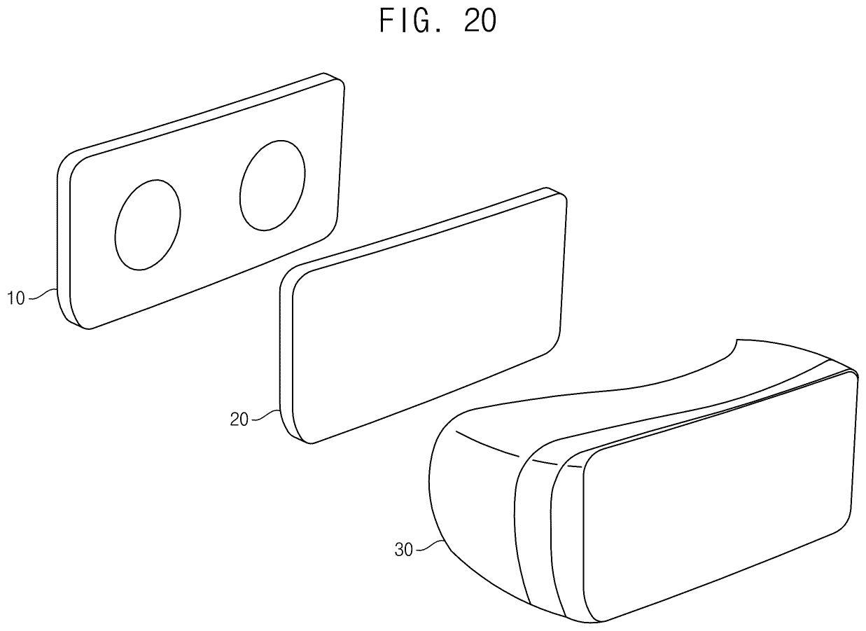

FIG. 18 is a block diagram illustrating an electronic device 1000 according to an embodiment of the present inventive concept. FIG. 19 is a diagram illustrating an example in which the electronic device of FIG. 18 is implemented as a smart phone.

Referring to FIG. 18, the electronic device 1000 may include a processor 1010, a memory device 1020, a storage device 1030, an input/output (I/O) device 1040, a power supply 1050, and a display device 1060. Here, the display device 1060 may be the display device of FIG. 1. Additionally, the electronic device 1000 may further include a plurality of ports for communicating with a video card, a sound card, a memory card, a universal serial bus (USB) device, other electronic device, etc.

In an embodiment, as illustrated in FIG. 19, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG, the app-on signal APPON and the input control signal CONT to the driving controller 200 of FIG. 1.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display device 1060 may be included in the I/O device 1040. The power supply 1050 may provide power for operations of the electronic device 1000. The display device 1060 may be coupled to other components via the buses or other communication links.

Referring to FIG. 19, the electronic device of the present inventive concept is shown implemented as a smartphone, but the present inventive concept is not limited thereto. The electronic device may be a television, a monitor, a laptop computer, or a tablet. Additionally, the electronic device may be a car.

FIG. 20 is a diagram illustrating an example in which the electronic device of FIG. 18 is implemented as a virtual reality display system.

Referring to FIG. 18 and FIG. 20, the virtual reality display system may include a lens unit 10, a display apparatus 20 and a housing 30. The display apparatus 20 is disposed adjacent to the lens unit 10. The housing 30 may receive the lens unit 10 and the display apparatus 20. Although the lens unit 10 and the display apparatus 20 are received in a first side of the housing 30 in FIG. 14, the present inventive concept may not be limited thereto. Alternatively, the lens unit 10 may be received in a first side of the housing 30 and the display apparatus may be received in a second side of the housing 30. When the lens unit 10 and the display apparatus 20 are received in the housing 30 in opposite sides, the housing 30 may have a transmission area to transmit a light.

For example, the virtual reality display system may be a head mounted display system which is wearable on a head of a user. Although not shown in figures, the virtual reality display system may further include a head band to fix the virtual reality display system on the head of the user.

Alternatively, the virtual reality display system may have the form of smart glasses implemented in the shape of glasses.

Additionally, the electronic device may be implemented as an augmented reality display system, a mixed reality display system, or an extended reality display system.

The display device according to the embodiments may be applied to a display device included in a computer, a notebook, a mobile phone, a smart phone, a smart pad, a PMP, a PDA, an MP3 player, or the like.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A display device comprising:
a display panel including a plurality of pixel circuits; and
a display panel driver configured to drive the display panel,
wherein the pixel circuit includes:
a first transistor including a control electrode connected to a first node, a first electrode receiving a first driving voltage and as second electrode connected to a second node;
a second transistor configured to apply a data voltage to a third node in response to a write gate signal;
a third transistor configured to connect the first node and the second node in response to a compensation gate signal;
a first capacitor including a first electrode connected to the third node and a second electrode connected to the first node; and
a light emitting element including a first electrode connected to the second node and a second electrode receiving a second driving voltage,
wherein the first driving voltage has a driving-high voltage or a driving-low voltage, and the second driving voltage has the driving-high voltage or the driving-low voltage, and
wherein the compensation gate signal is a global signal that is globally applied to at least two pixel-rows with a same timing.

2. The display device of claim 1, wherein the pixel circuit further includes a fourth transistor configured to apply an initialization voltage to the second node in response to an initialization gate signal, and
wherein the initialization voltage signal is globally applied.

3. The display device of claim 2, wherein the pixel circuit further includes a second capacitor including a first electrode receiving the initialization voltage and a second electrode connected to the third node.

4. The display device of claim 1, wherein the pixel circuit further includes a fourth transistor configured to apply an initialization voltage to the second node in response to an initialization gate signal,
wherein a frame period in which the pixel circuit is driven includes first to seventh periods, and
wherein in the first period, the compensation gate signal has an inactive level, the initialization gate signal has an inactive level, the write gate signal has an inactive level, and the second driving voltage has the driving-high voltage.

5. The display device of claim 4, wherein in the second period following the first period, the compensation gate signal has an active level, the initialization gate signal has an active level, the write gate signal has an active level, the data voltage has a reference data voltage, and the first driving voltage has the driving-low voltage.

6. The display device of claim 5, wherein in the third period following the second period, the compensation gate signal has an active level, the initialization gate signal has an inactive level, the write gate signal has an active level, and the first driving voltage has the driving-high voltage.

7. The display device of claim 6, wherein in the fourth period following the third period, the compensation gate signal has an inactive level, the initialization gate signal has an inactive level, the write gate signal has an inactive level, and the first driving voltage transitions between the driving-high voltage and the driving-low voltage.

8. The display device of claim 6, wherein in the fourth period following the third period, the compensation gate signal has an inactive level, the initialization gate signal has an inactive level, the write gate signal has an inactive level, and the first driving voltage has the driving-high voltage.

9. The display device of claim 8, wherein in the fifth period following the fourth period, the write gate signal has an active level, the data voltage has a pixel data voltage, and the first driving voltage has the driving-low voltage.

10. The display device of claim 8, wherein in the fifth period following the fourth period, the write gate signal has an active level, the data voltage has a pixel data voltage, and the first driving voltage has the driving-high voltage.

11. The display device of claim 10, wherein in the sixth period following the fifth period, the compensation gate signal has an inactive level, the initialization gate signal has an active level, the write gate signal has an inactive level, and the first driving voltage has the driving-high voltage.

12. The display device of claim 10, wherein in the sixth period following the fifth period, the compensation gate signal has an inactive level, the initialization gate signal has an active level, the write gate signal has an inactive level, and the first driving voltage has the driving-low voltage.

13. The display device of claim 12, wherein in the seventh period following the sixth period, the compensation gate signal has an inactive level, the initialization gate signal has an active level, the write gate signal has an inactive level, the first driving voltage has the driving-high voltage, and the second driving voltage has the driving-low voltage.

14. The display device of claim 1, wherein the pixel circuit further includes a fourth transistor configured to apply an initialization voltage to the second node in response to an initialization gate signal, and
wherein the first transistor is a P-type transistor, and the second to fourth transistors are N-type transistors.

15. The display device of claim 1, wherein the pixel circuit further includes:
a fourth transistor configured to apply an initialization voltage to the second node in response to an initialization gate signal; and
a second capacitor including a first electrode receiving the initialization voltage and a second electrode connected to the third node,
wherein the second transistor includes a control electrode receiving the write gate signal, a first electrode receiving the data voltage and a second electrode connected to the third node,
wherein the third transistor includes a control electrode receiving the compensation gate signal, a first electrode connected to the second node and a second electrode connected to the first node, and
wherein the fourth transistor includes a control electrode receiving the initialization gate signal, a first electrode receiving the initialization voltage and a second electrode connected to the second node.

16. A pixel circuit comprising:
a first transistor including a control electrode connected to a first node, a first electrode receiving a first driving voltage and a second electrode connected to a second node;
a second transistor including a control electrode receiving a write gate signal, a first electrode receiving a data voltage and a second electrode connected to a third node;
a third transistor including a control electrode receiving a compensation gate signal, a first electrode connected to the second node and a second electrode connected to the first node;
a fourth transistor including a control electrode receiving an initialization gate signal, a first electrode receiving an initialization voltage and a second electrode connected to the second node;
a first capacitor including a first electrode connected to the third node and a second electrode connected to the first node;
a second capacitor including a first electrode receiving a reference voltage and a second electrode connected to the third node; and
a light emitting element including a first electrode connected to the second node and a second electrode receiving a second driving voltage,
wherein the first driving voltage and the second driving voltage change during a frame period.

17. The pixel circuit of claim 16, wherein the frame period in which the pixel circuit is driven includes a first initialization period, a compensation period, a writing period, a second initialization period and an emission period,
wherein in the first initialization period, the compensation gate signal has an active level, the initialization gate signal has an active level, the write gate signal has an active level, the data voltage has a reference data voltage, the first driving voltage has a driving-low voltage, and the second driving voltage has the driving-high voltage,
wherein in the compensation period, the compensation gate signal has an active level, the initialization gate signal has an inactive level, the first driving voltage has a driving-high voltage, and the second driving voltage has the driving-high voltage,
wherein in the writing period, the write gate signal has an active level for part of the writing period, the data voltage has a pixel data voltage, the first driving voltage has a driving-low voltage, and the second driving voltage has the driving-high voltage,
wherein in the second initialization period, the initialization gate signal has an active level, the write gate signal has an active level, the first driving voltage has a driving-low voltage, and the second driving voltage has the driving-high voltage, and
wherein in the emission period, the first driving voltage has a driving-high voltage, and the second driving voltage has the driving-low voltage.

18. The pixel circuit of claim 16, wherein the first transistor is a P-type transistor, and the second to fourth transistors are N-type transistors.

19. The pixel circuit of claim 16, wherein the reference voltage is the initialization voltage.

20. An electronic device comprising:
a display panel including a plurality of pixel circuits;
a display panel driver configured to drive the display panel based on an input control signal; and
a processor configured to output the input control signal,
wherein the pixel circuit includes:
a first transistor including a control electrode connected to a first node, a first electrode receiving a first driving voltage and as second electrode connected to a second node;
a second transistor configured to apply a data voltage to a third node in response to a write gate signal;
a third transistor configured to connect the first node and the second node in response to a compensation gate signal;
a first capacitor including a first electrode connected to the third node and a second electrode connected to the first node; and
a light emitting element including a first electrode connected to the second node and a second electrode receiving a second driving voltage,
wherein the first driving voltage has a driving-high voltage or a driving-low voltage, and the second driving voltage has the driving-high voltage or the driving-low voltage, and
wherein the compensation gate signal is a global signal that is globally applied to at least two pixel-rows with a same timing.
